(19) United States
(12) Patent Application Publication
(10) Pub. No.: US 2023/0076458 A1
(43) Pub. Date: Mar. 9, 2023

(54) Offline links to online data

(71) Applicant: Wesley John Boudville, Perth (AU)

(72) Inventor: Wesley John Boudville, Perth (AU)

(21) Appl. No.: 17/300,641

(22) Filed: Sep. 9, 2021

(51) Int. Cl. G06Q 30/02; G06F 16/33; G06F 16/332; G06K 9/00

(52) U.S. Cl. CPC G06Q 30/0255; G06Q 30/0261; G06F 16/3335; G06F 16/3329; G06K 9/00463; G06K 2209/01

(57) ABSTRACT

We describe offline links to online digital assets. The offline links can be in hardcopy text. A link can be in a format like [BBQ Ribs], where there is a starting delimiter (eg “[”) and a closing delimiter (“]”). We call this a “linket”. A user has a mobile device with a camera. She scans a linket in hardcopy she is reading. Her device converts this to digital form and sends to a server. The server maps the linket to an URL or other electronic data. The linket acts as a brand, akin to a domain name.

### TECHNICAL FIELD

Printed and electronic media, websites and mobile apps.

### BACKGROUND

The Web has grown massively in over 30 years. Some 300 million domains exists and millions of websites. Plus there is a parallel group of mobile apps that run on mobile devices. So great has been this growth that it turned traditional hard copy newspapers, magazines and books into stunted poor relatives of their online counterparts.

Now typically, a magazine exists mostly in electronic form (usually as a PDF). Only in some cases is it considered desirable or necessary to make a printed version. And in this latter case, the PDF is merely printed out.

### BRIEF DESCRIPTION OF THE DRAWINGS

FIG. 1 shows a hardcopy printed page with text and linkets.

FIG. 2 shows linkets in several languages.

FIG. 3 shows a user scanning a linket from FIG. 1.

FIG. 4 shows a QR code and a Data Matrix code.

FIG. 5 shows QR codes interspersed with text.

FIG. 6 compares offline and online queries and recommendations.

FIG. 7 shows a publisher making linkets for offline and online.

FIG. 8 shows the auction of destinations after hardcopy is printed.

FIG. 9 shows the user mobile device and its server.

FIG. 10 shows devices of Jill, Bob and Dee.

FIG. 11 shows Bob and Jill's devices interacting.

FIG. 12 shows formats of a linket.

FIG. 13 is about making possible linkets.

FIG. 14 shows OSPF between Jill's device and a web server.

FIG. 15 shows how a TV feed can be analyzed.

FIG. 16 shows finding linkets and time codes from a TV video feed.

FIG. 17 shows spoken word and a linket derived from it.

### REFERENCES

### Detailed Description of the Preferred Embodiment

What we claim as new and desire to secure by letters patent is set forth in the following. This application has the following sections:
1: Base case—Smart OCR;
2: Server picking a webpage;
3: Server picking a mobile app;
4: Publisher making linkets;
5: Linket formats;
6: Scanning text to find linkets;
7: Improved energy efficiency;
8: Social justice;
9: Column oriented linkets;
10: Auditory search;
11: Changing linkets;
12: Edge storage;
13: Variants;
14: TV and video feeds;
14.1: Graphics;
14.2: Spoken;
14.3: Sounds/music;
   1: Base case;

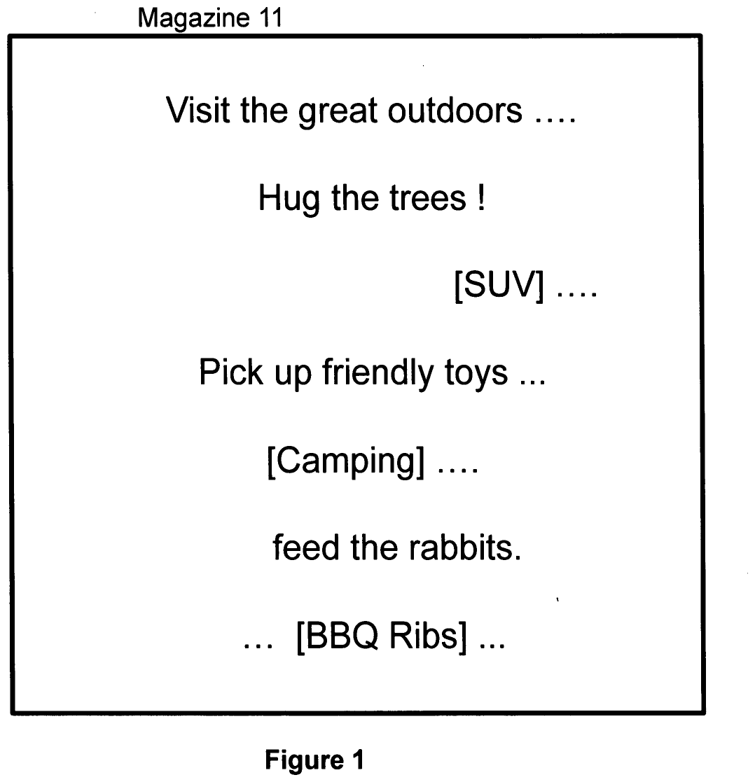

FIG. 1 shows an example hardcopy Magazine 11, which might have an article on going camping and seeing nature. Interspersed thru the article might be ads for camping equipment, SUVs and for BBQ ribs. The ads might have text and images. FIG. 1 introduces linkets, which are ways to format short text portions of the ads.

The linkets might have delimiting characters, like left (‘[’) and right (‘]’) brackets. The choice of delimiters is arbitrary. For example, there might be left and right round brackets (‘(’ and ‘)’), or left and right curly brackets (‘{’ and ‘}’) or left and right angle brackets (‘<’ and ‘>’).

An alternative is underlining the linket text. This is possible. An issue can be ambiguity between this indicator of a linket and using underlining to stress the chosen text. Another source of ambiguity is a third meaning of the underlining—where it designates that the underlined text is a hyperlink if such a thing was physically possible with hardcopy.

The use of matching left and right delimiters is also arbitrary but suggested. This has the useful feature that internal white space is permitted inside the brackets. In contrast to domain names, which might be like rundog.com or redcar.com. The reason for the suppression of internal white space in domains is because there is no simple way to indicate where a domain name ends. Hashtags also suffer from the same drawback.

White space was invented when alphabet based languages were invented in the Bronze Age, so that words would be separated from each other and more easily read. This was a fundamental invention for written language and for this reason we use opening and closing (or left and right) delimiters.

The way that hashtags are written in Chinese also illustrates this. Suppose a Chinese hashtag has 3 pictograms, A, B and C. The hashtag is usually written as #ABC # with a trailing “#”. Because in Chinese when written left to right, there is usually no whitespace. For if, excluding hashtags, there are the pictograms DEFG written as such, this is normal. No whitespace between D and E etc. Now prepend a hashtag just written as #ABC. We get #ABCDEFG. This does not make sense, in general. The reader cannot tell where the hashtag ends and the non-hashtag symbols begin, because Chinese has no whitespace. So the hashtag must be written as #ABC #DEFG.

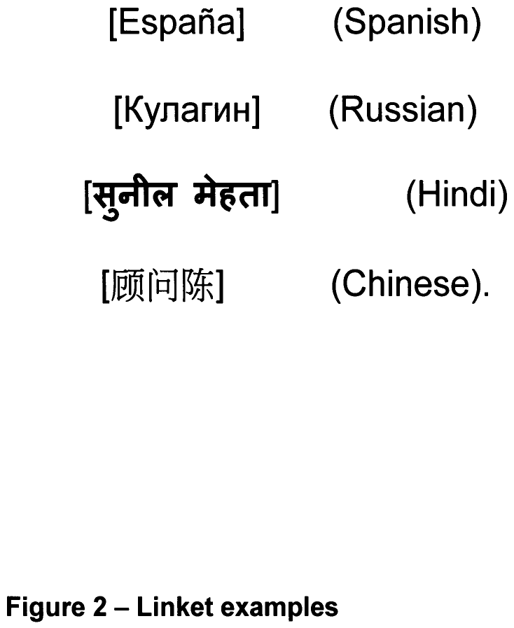

The contents of a linket can be in any language if Unicode is used to write the symbols. Unicode was invented in the 1990s to be a systematic way to write all languages. In the examples in this application, the contents of a linket will usually be in Roman letters, and specifically be English words. But this is purely as examples. The reader should keep in mind that linkets can be in any language, as shown in FIG. 2.

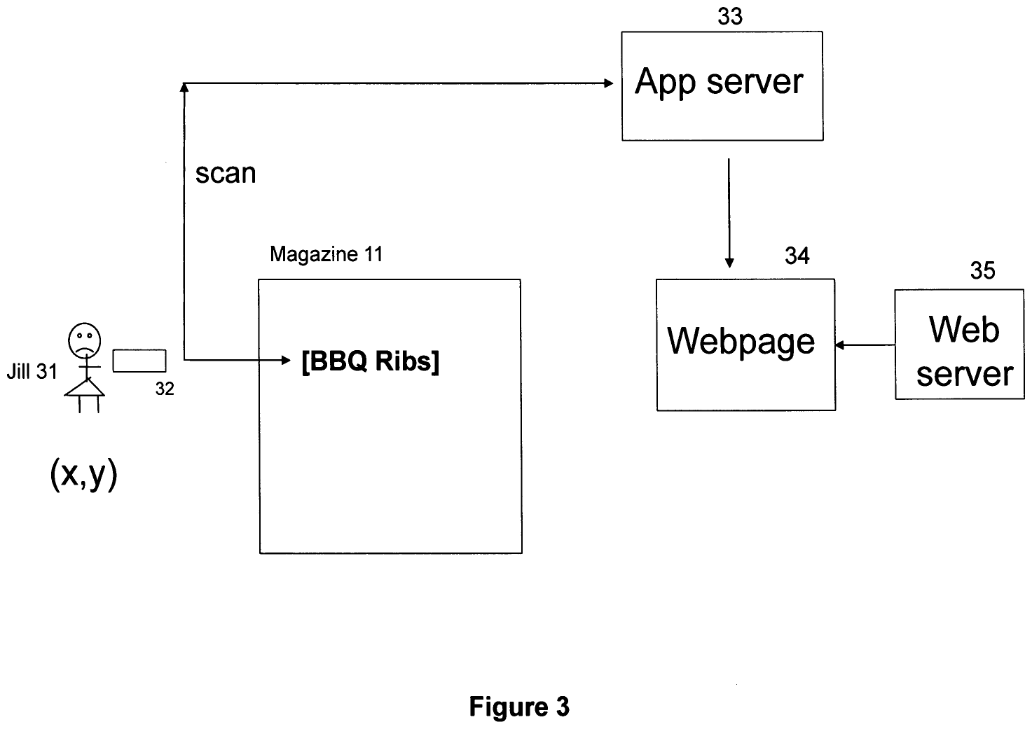

FIG. 3 shows a user Jill 31 with mobile device 32. She is at a latitude-longitude location (x, y). She is reading Magazine 11. It has the 3 linkets of FIG. 1—[SUV], [Camping], [BBQ Ribs]. Device 32 has a camera and Jill uses her device to scan [BBQ Ribs] into an electronic format. Device 32 has a mobile app designed to detect linkets written in this format. The opening and closing brackets help the device in isolating the text upon which to run Optical Character Recognition (OCR).

Device 32 has a wireless Internet connection. Its mobile app connects to server 33 and sends it the decoded text string [BBQ Ribs]. Device 32 optionally also sends its (x, y) to server 33. The server makes some decision and can send to device 32 a webpage 34. Equivalently it should be understood that server 33 can just send to device 32 the URL address of webpage 34. The latter can come from web server 35. (For simplicity, some steps have been omitted.) Server 35 might be the server for a restaurant near Jill that owns the [BBQ Ribs] linket. Or Web server 35 might own [BBQ Ribs] linket and it makes webpage 34 which Jill sees. But if Jill places an order, it is sent to a nearby restaurant which with partners with server 35. While if a different user scans a different copy of the hardcopy in a different region, then a buy order goes to a different restaurant, closer to that user.

There is a case where even though [BBQ Ribs] was the linket scanned by Jill, the server might also consider linkets of other names, where these linkets are deemed to be about the same subject (eg BBQ or ribs). Here the server might decide to use Jill's location as a parameter in reducing the choices sent to her device. The server could pick a linket closest to her, for speedy access by her.

The end result is the same. Jill's device can show webpage 34. This might be a webpage of a restaurant near her, selling BBQ ribs.

The method of the previous paragraph can be done when there is no exact match between the scanned linket [BBQ Ribs] and the linkets in the database. But it might also be done even if there is an exact match. Here, the server might in its database have information about similar products or services. (Which might be considered similar topics of interest to Jill.) So the server could send a reply to Jill's device that has linkets for these cases as well as a possible exact match.

A countermeasure is possible, where the owner of [BBQ Ribs] could pay the publisher an extra fee, to omit these competitors' linkets appearing in the results sent to the end user.

The overall method of FIG. 1 might be termed “Smart OCR”. It uses OCR technology largely developed in the 1980s, prior to the rise of the Web. OCR methods are now highly developed and stable. The main difference between the methods of the 1980s and now might be that now device 32 is a mobile device like a cellphone. In the 80s, cellphones were few and very limited in abilities.

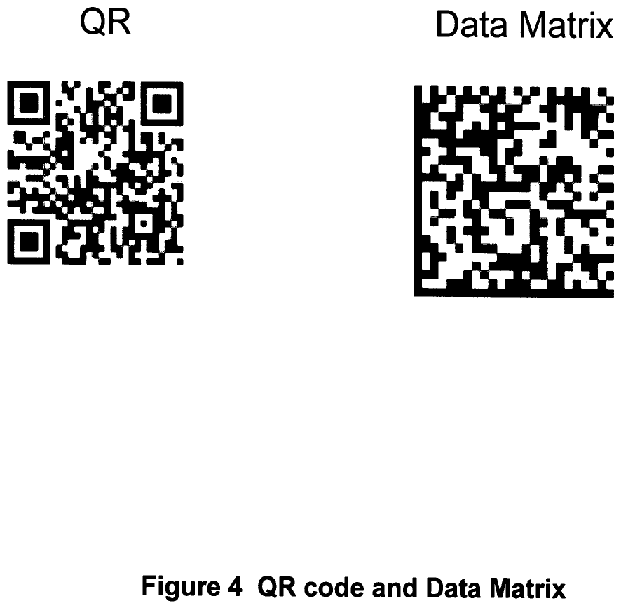

FIG. 4 shows an example of a QR code and a Data Matrix code. In the US these are the most common types of 2 dimensional barcodes. Whereas in Asia the QR code dominates. The QR and Data Matrix codes have roughly equivalent functionality.

Note that 2d barcodes often have Error Correction Codes (ECC) that are used to decode the barcode into text. While raw text like [BBQ Ribs] has no built in error correction. But we suggest that today's OCR software is highly developed and can scan common raw text without much need for error correction. Especially if the text is written in a commonly used font like Helvetica or Arial. And perhaps also if the font has simple strokes and does not have elaborate “feet” (serifs).

A question immediately arises. Instead of scanning the linkets with OCR, why not have the linkets written as QR codes and then Jill uses a QR decoder to decode the linkets? Today QR decoders are commonly available as mobile apps and often are free. Also, some mobile devices come with a QR decoder already pre-installed as part of the operating system.

One answer is that OCR decoding should be robust enough, without needing the extra computational burden of decoding a QR code. But a deeper answer has to do with the linket being readable directly by the reader Jill. She can just read and understand [BBQ Ribs] or the other linkets, without the use of any computers. This means that a short linket like [BBQ Ribs] can be remembered by her. Later, when she might be at a PC, she might be able to type in [BBQ Ribs] into some program and see where that goes to in the computer.

Thus linkets can be remembered as brands. This can be immensely valuable to advertisers and marketers. A useful analogy is to domain names that are considered valuable in the marketplace. There is a thriving secondary market where domains are bought and sold. Some domains have sold for millions of dollars, like business.com, boston.com, cars.com. These are usually dot com domains, where the domain name is often English and having obvious commercial value as a brand.

The [BBQ Ribs] example can also show a difference with traditional domain names. Imagine that there might be a domain bbqRibs.com. The owner of this domain is guaranteed that he has a globally unique domain. This is true for any of the 300 million domains currently existing. But the owner of [BBQ Ribs] can take a different approach. If he is in the US, he can divide up the US into different regions. If Jill, based on her (x, y), is in Utah, Webpage 34 can point to a vendor near her. If Jill's (x, y) is in Florida, Webpage 34 points to a vendor in Florida. The linket brand subcontracts to local vendors.

When considering a QR code, it is meaningless to a nearby human. She needs a QR decoder device in order to get a result meaningful to her. Plus if we look at the QR code in FIG. 3, it is square. Putting a QR into a written text narrative can be jarring. The esthetics of a pseudorandom black and white QR pattern might be off putting to some readers. Whereas a linket likely can fit seamlessly into the existing narrative.

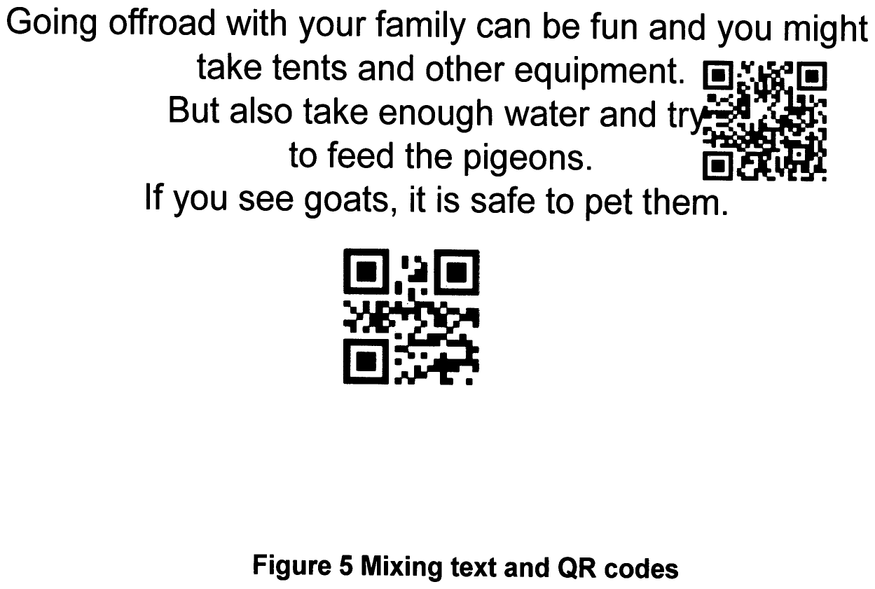

FIG. 5 shows a snippet of text with 2 QR codes embedded. The combination might be considered discordant by writers or graphics artists. The square nature of QR codes is intrinsic to their current use and can be jarring with trying to fit with row-based text. Plus there is a limit to how small a QR code can be shown, even with ECC. Whereas FIG. 2 shows how linkets blend naturally and are compatible with row based text.

It can be said that readers are very familiar with a page (hardcopy or webpage) that has text interspersed with images. But usually those images are just that. Images of real or imaginary items that fit into the narrative of the text. From the examples provided here of barcodes, the barcodes do not fit easily into that framework of “useful” or relevant images. An image of a tree can be understood by the reader to be a tree. But a barcode's ultimate meaning can only be discerned after it has been decoded by a machine.

2: Server Picking a Webpage;

Consider again FIG. 3. There can be many elaborations on how the server picks a webpage to send to user Jill. The server might know data on Jill's buying history, through her purchases on an ecommerce site, or thru her email site or thru social networks that she uses.

The server could take the approach of a search engine, by a free (organic) listing of BBQ sites, perhaps with a separate list of paid results. The latter might be found by an automated electronic auction, where sellers offering BBQ might bid for placement into the paid results.

A major value of the mechanism of FIG. 3 is that it is a way to break the de facto monopoly of much of ecommerce by a few major firms like AMAZON CORP, GOOGLE CORP and FACEBOOK CORP. At the simplest level, they control a mapping from an online query to an online recommendation.

But the mapping from an offline text to an online recommendation is largely not done.

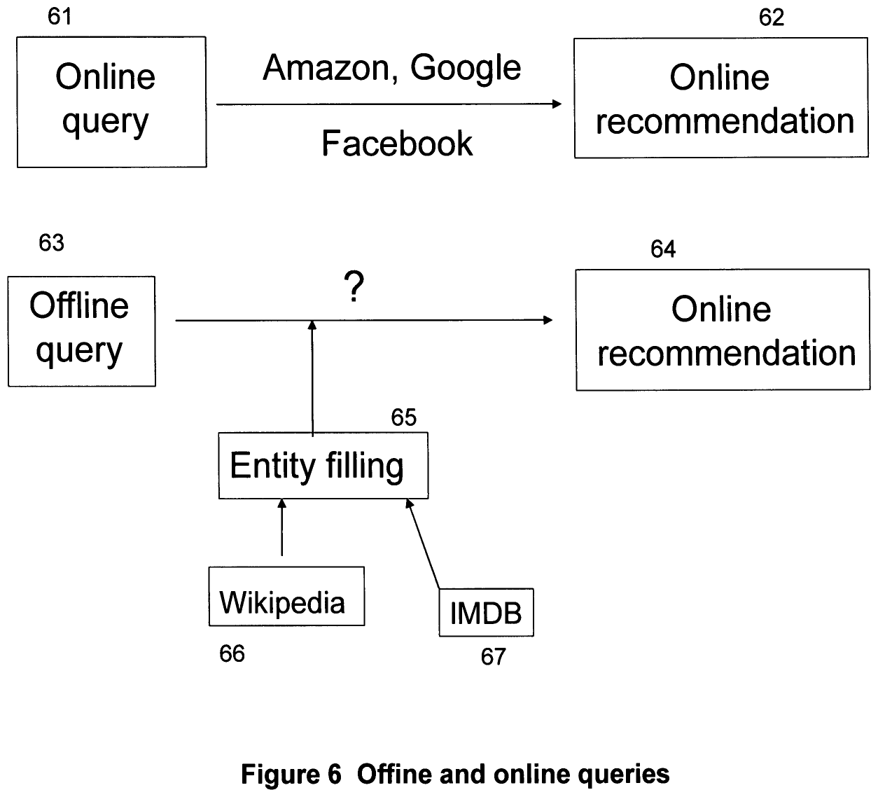

FIG. 6 shows online query 61 pointing to online recommendation 62. The arrow from 61 to 62 is controlled in large part by the above 3 firms. In contrast, offline query 63 points to online recommendation 64. This is largely out of the control of those large players. This step from item 63 to item 64 is an emphasis of this application.

To make the offline actions feasible, item 65, entity filling, needs to be done. An entity is an object like BBQ or BBQ Ribs as in the earlier examples. It is in general a noun that is an object that might be under discussion or be asked for or about. A database of entities needs to be made, perhaps initially in some (semi-) automated fashion. Two examples are given of databases, Wikipedia and IMDB. The movie database can be used to find data on movies and actors. Readers might be interested in old or upcoming movies and the actors in them. Many other example databases can be imagined.

A spider program can be used to process entries in Wikipedia, for example. The spider extracts nouns that might be the (current) topics in Wikipedia. If a noun is, say, poker, the linket [Poker] can be made. The Wikipedia page, on poker can be converted to an information page about [Poker]. More elaborate methods can be devised but this is an example of the gist.

An equivalent alternative is that for [Poker], the spider finds the URL of the poker page. And the spider associates [Poker] with the URL. This has the benefit of not copying the Wikipedia page, and if the latter is altered by Wikipedia editors, the changes automatically apply to [Poker].

A use of the filled entities is to have information about a broad range of entities available to users of this application. But the main effort is to find an online recommendation 64 for the user. The overall value of this application comes in being able to find germane recommendations.

3: Server Picking a Mobile App;

A linket can point to a given app in a mobile app store. And to a given page or user in that app. This vastly extends an earlier simple use of a linket to point to an URL of a website. This also can give rise to a different type of interaction than a straightforward ecommerce model.

4: Publisher Making Linkets;

Consider FIG. 3, where Jill scans an offline document that has [BBQ Ribs]. Prior to the document being printed, the publisher might define various linkets to be put into the document. A linket made this way might come from 1 or 2 means.

First. In the main text of the document, there might be the string “BBQ ribs”. This could be converted to the linket [BBQ Ribs]. Then in a database run by the publisher, there might be a mapping made from [BBQ Ribs] to an URL of a restaurant selling the ribs. More elaborately, instead of an URL there might be a data structure that includes an URL, but also data items like the location of the restaurant, a typical price of the item, the hours of opening etc.

Second. The main text of the document might be about visiting some rural area. But the linket [BBQ Ribs] is in essence an ad laid out in some part of the hardcopy. Here the main text might not even mention ribs or BBQ.

In both cases, since the final version of the linket is to appear on a hardcopy page, there might also be around the linket a phone number or address of the location, for users who do not pick the linket.

The publisher making the document can manually put in such linkets, that point to ads. The publisher wants revenue when a reader scans and clicks an offline ad on her mobile app, and thus goes to the data pointed to by the linket.

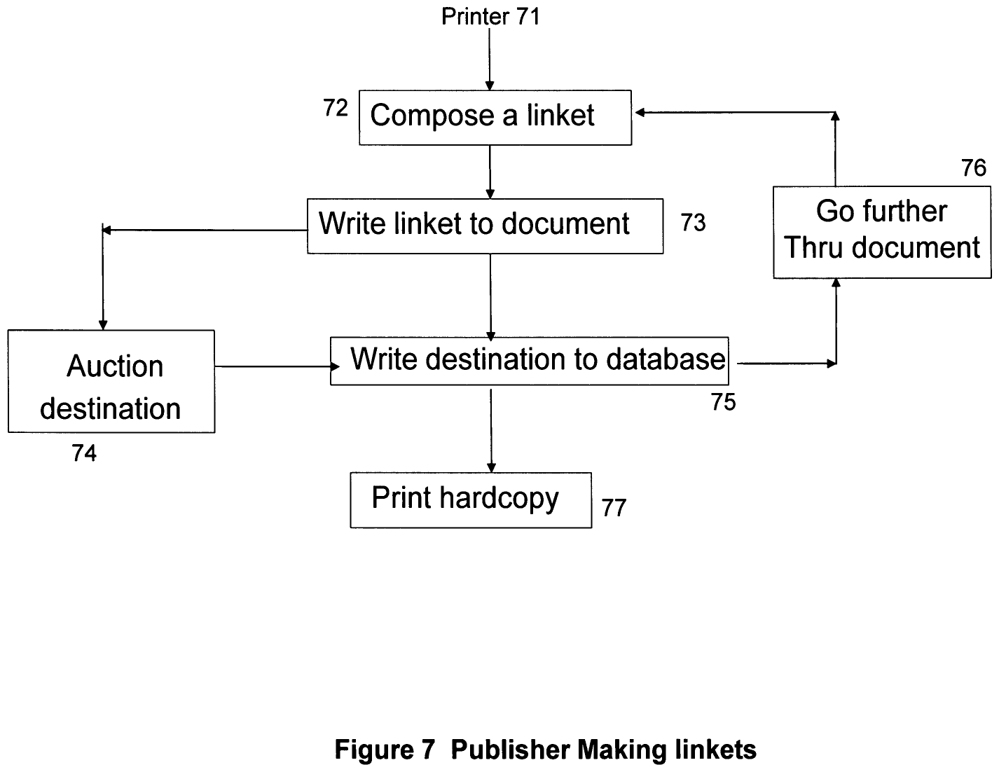

FIG. 7 shows a simplified flow chart. It is done by the publisher making an offline document. Start at item 71. Item 72 is the composing of a linket. Whether it is a separate ad from the non-ad part of the text or whether it is inline as part of the text. Item 73 is the writing of the linket to the document, where the document is, for now, held in computer memory.

Now there can be 2 choices. Item 74 is where for that chosen linket, an auction is held to find the destination pointed to by the linket. Or instead item 75 can be done immediately after item 73. The decision to do one of item 74 exor 75 involves external logic. Items 72 to 76 might be iterated to go thru the document and define other linkets. Implicit in item 75 is a test for whether we are at the end of the (electronic) document or not. If we are at the end then go to item 77, else go to item 76.

Item 77 is the publisher doing the hardcopy printing of the completed document.

A variant of the above is to look at item 74. The finding of the destination can be deferred. The publisher can wait. The hardcopy might not be distributed until days or weeks later. Thus item 75 can merely be an entry in the database that is initially undetermined.

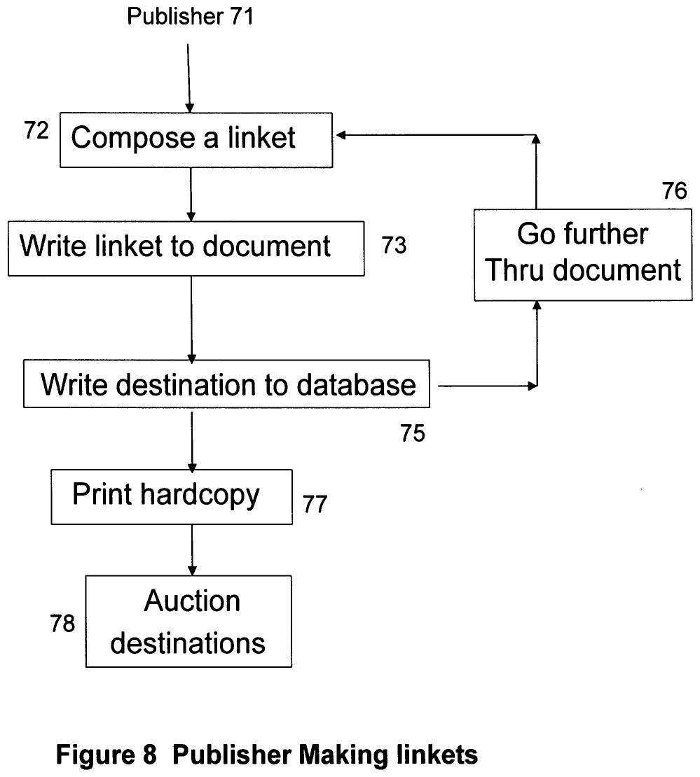

A variant of FIG. 7 is FIG. 8. Item 74 is replaced by item 78, which is now done AFTER hardcopy is printed. Unlike item 74, here there are several auctions done because the hardcopy may have several linkets whose destinations need to be found. These might be auctions held simultaneously, for some or all of the destinations. If some destinations are not sold, there might still be auctions done at later times for unsold items.

One contingency is to note that hardcopy can exist indefinitely in the real world, unlike webpages which can be amended or taken down at any time. So if a linket is (eg) [Fat Chips] and is printed on some papers, a record can be kept in the publisher's database, that [Fat Chips] was made at some date. This record can be maintained. A year after most of the hardcopy that mentioned [Fat Chips] was discarded, the publisher's server might still get a query from a customer for [Fat Chips]. The publisher needs to decide, either before that query or when it is received, what decision to make. In general, the publisher can forward the query to the advertiser that owns [Fat Chips].

If the product is a food item, perhaps the advertiser can still make it as a special order. Even if the advertiser loses money on it, simply to keep goodwill with a paying customer. Or the advertiser might issue an electronic receipt for a certain amount, to let the customer buy something of that value.

If the product is a digital item, the advertiser might have a newer version at a different price. The advertiser might send a message to the user about this, letting her decide whether to buy the newer item or not.

Now let user Jill pick [BBQ Ribs] via her device. The restaurant pointed to does not need to use the large Internet firms like FACEBOOK CORP or GOOGLE CORP.

One possible ambiguity needs to be clarified. A linket can have a price, which is the price it was bought from the Registrar of the linket. But if the linket refers to an item the item itself has a price. For [BBQ Ribs], for a certain quantity of ribs, the price might be $15. But to own the linket string [BBQ Ribs] for 1 year might cost $10. In the context of this specification, the price most typically associated with a linket is the price of the item.

Another case is Jill scans a hardcopy linket [BBQ Ribs]. Her device does an OCR decode to get the digital [BBQ Ribs] and sends this to the server to check the status. If previous users have bought all the ribs, the server sends a message to her app, “Cannot order”. The digital string [BBQ Ribs] might never be shown on her screen as being decoded via OCR, even though the OCR was successful in doing so. Here, the hardcopy linket is not visibly decoded into a digital form.

Another case is where user Jill scans hardcopy text with no visible linket in it. When she scans with her device, it decodes the text (incrementally) and sends the decoded text to its server, which searches for text that might be an invisible linket. Suppose the text says, in part, “Bob works at a BBQ place”. The server gets the electronic “BBQ” and finds a registered linket in its database, “[BBQ Ribs]”. And the status of this linket is that it points to an active vendor able to supply the item. The server sends a message to the app, “[BBQ Ribs] is open” and the app shows it on its screen to Jill. Plus the electronic string “[BBQ Ribs]” can be picked by Jill. It might be a hyperlink. Note also that [BBQ Ribs] never existed in the hardcopy. It is an extrapolation by her app from the hardcopy.

The earlier cases were where what Jill sees on her screen does not have to exactly match what she sees in hardcopy in front of her. Another case refers to the physical printing of new hardcopy. Imagine Jill is in some town where she picks up a hardcopy paper. It has [BBQ Ribs]. If she and enough others around her scan it and place orders, the advertiser can use the orders and the locations of Jill et al to determine that more physical copies of the paper are printed with the linket in them, and the papers can be distributed in her neighborhood.

Or if few or even no [BBQ Ribs] are scanned by her and others in her area, then future distributions of the paper in her area can omit [BBQ Ribs].

5: Linket Formats;

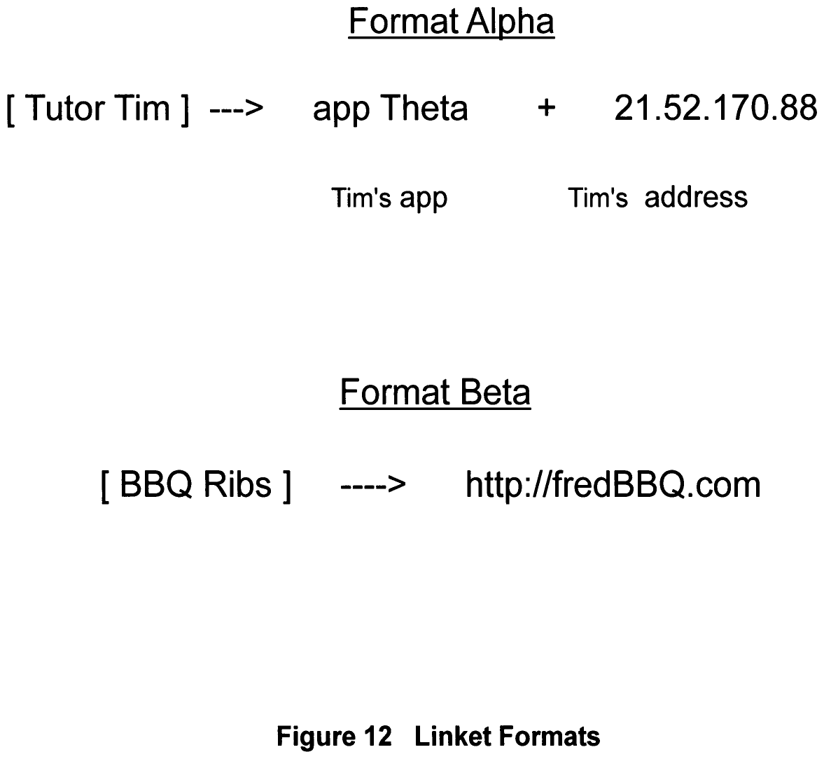

FIG. 12 shows the formats of a linket as we used in earlier applications. The first example is a linket [Tutor Tim]. It maps to a tutoring app called app Theta that Tim has picked as the app he will use. The linket also maps to Tim's current Internet Protocol (IP) address of 21.52.170.88. Here the IP address is given in IPv4 format, but an IPv6 format could have been used. This first example means that Tim's linket when pressed by a student (customer) in the student's mobile browser will cause an instance of the app to be installed and run on the student's phone. The app instance will be loaded with the address of Tim's instance. We call this format Alpha.

A different approach is shown in the second example. The linket [BBQ Ribs] points to an URL for a restaurant fredBBQ.com. Here the linket is equivalent to an URL redirection. We term this format Beta.

Both examples were for an electronic linket being clicked in a webpage or mobile app of a mobile device. Neither were for a linket written in hardcopy and then scanned by a mobile device. In this application both formats can be used by the mobile scanner app that scanned the hardcopy linket to make the electronic linket. The question of which format to use can be left to the app.

The simpler case is format Beta. The scanner app has found [BBQ Ribs] in digital form after scanning. The scanner searches its database and finds the URL for fredBBQ.com and uses this by loading it into the mobile browser or into an app that can do the quivalent of acting as a quasi browser by showing in part the webpage for fredBBQ.com. Note that this is essentially for a person to machine interaction. User Jill ends up at a webpage where she can order ribs. This is often done by the restaurant having Jill interact entirely with a machine, to reduce the cost of having a person manually interact with Jill.

For format Alpha, imagine that Jill reads a hardcopy and sees [Tutor Tim]. Possibly with explanatory text about Tim being a tutor in some subject. Jill agrees and scans the linket. This goes to the scanner's database. It finds that Tim has picked the app Theta to be used by the student (Jill). And that at this point in time, when Jill scanned, Tim is online at 21.52.170.88. Hence the data in the format Alpha example is used. If Tim is offline, he might have a tutoring partner at a different address who can handle the interaction with Jill.

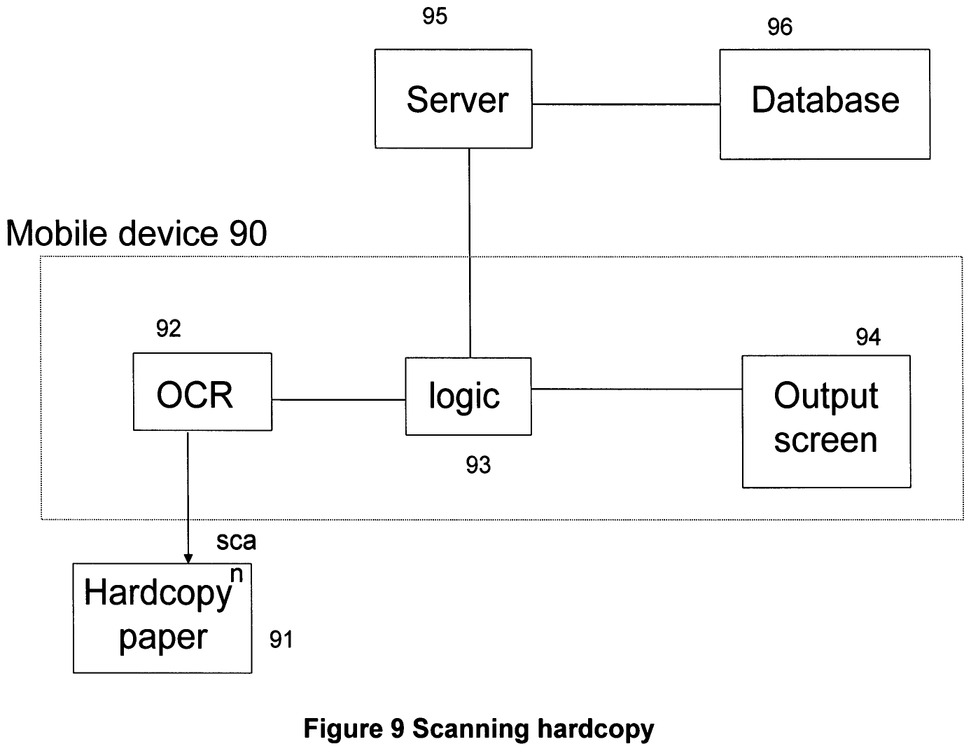

FIG. 9 shows Jill's device interacting with its server. Her device is represented by items 92, 93 and 94. Item 92 is the core OCR hardware that scans hardcopy paper 91. But the OCR output goes to logic 93. The logic sends the scanned output to server 95. The server uses its database 96. Based on the scanned input from OCR 92 and previous history stored in the database, the server sends control messages to logic 93, which then writes electronic output to the screen 94 of Jill's mobile device. When Jill sees what is on her screen, it is not a simple and literal OCR decoding of the paper she is reading.

FIG. 9 implies the current or previous presence of other users, each with an equivalent device containing instances of items 92, 93 and 94. For clarity, other functionality has been omitted from FIG. 9. Like the ability for Jill to pick items on the output screen. For example

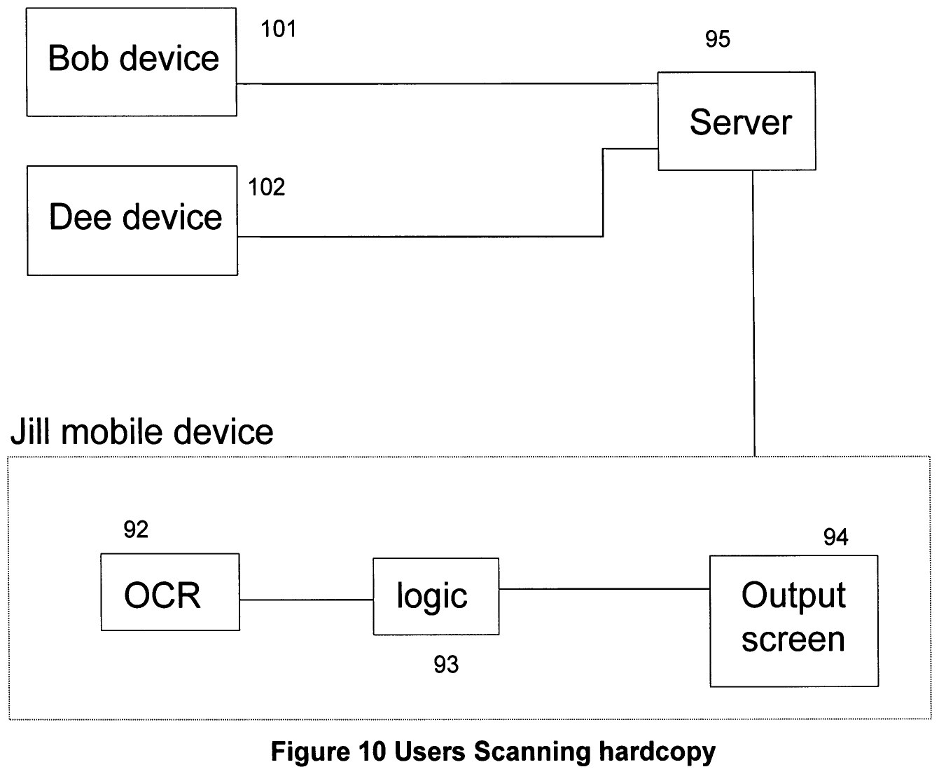

FIG. 10 shows 3 users and their mobile devices interacting with the server. The Jill mobile app is from FIG. 9. Item 101 is Bob's mobile device. Item 102 is Dee's mobile device. Bob and Dee's devices have the equivalent functionality of Jill's device. In general, they do not know each other and they are at different locations. Each is assumed to have picked up the same paper and are reading it. Bob and Dee each pick [BBQ Ribs] on their devices and each places an order. The net effect is that the restaurant cannot fulfill a third order. The restaurant's server communicates this to server 95. In turn, server 95 sends a signal to Jill's screen 94, to turn off [BBQ Ribs] so that she cannot place an order for it.

What Jill sees on her screen is not a simple literal output of her OCR, but the networked total of other remote interactions of other users and their devices.

When we said the scanner app looks up the linket in its database, a simple alternative is where the app sends the linket to a server to do the lookup. This is equivalent.

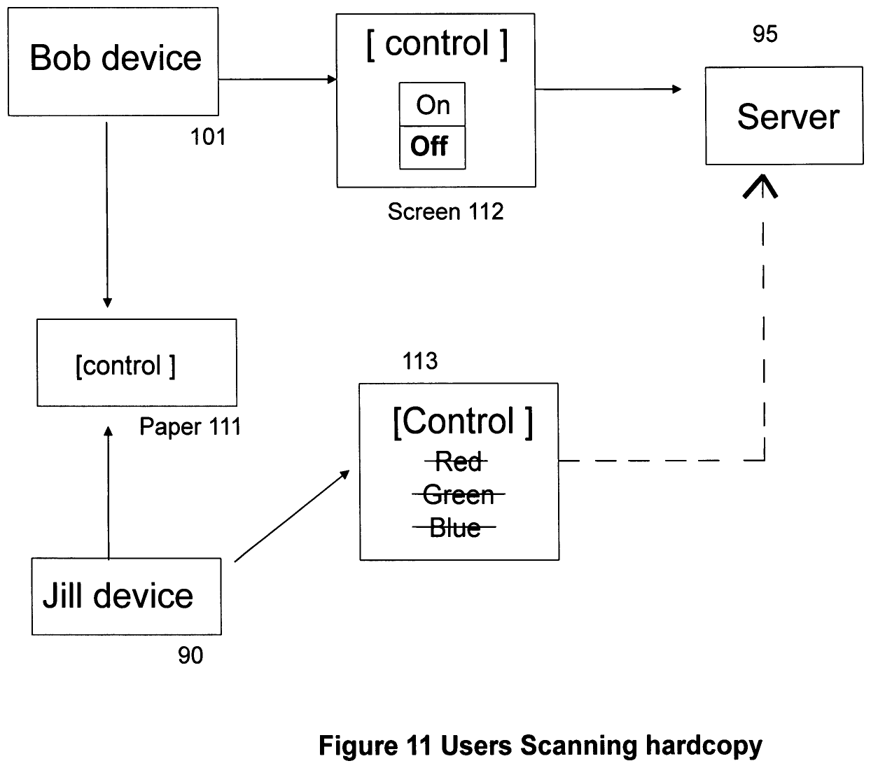

We can generalize FIG. 10 to FIG. 11. It shows Bob's device 101 and Jill's device 90. Both devices read the same hardcopy paper 111. Or equivalently, each device reads a copy of paper 111. But Bob reads first. It has 1 linket in hardcopy, saying [control]. Bob's device sends the electronic [control] to server 95 and gets back the contents of screen 112. Think of 112 as a typical HTML webpage or a mobile app page. It has 2 radio buttons, saying On and Off. The Off button is highlighted in bold to indicate that Bob picked it.

Jill comes along and scans paper 111. She gets screen 113 from the server. Bob pressing Off in 112 causes the server to draw a new version (=item 113) that has 3 clickable buttons or links, saying Red, Green and Blue. And the buttons are shown with strikethroughs, indicating that they are disabled. Likewise, the arrow from 113 to the server is shown in dashes, to indicate that she cannot send a signal from her screen to the server.

Bob gained this supervisory ability over Jill's choices in several possible ways. He could have simply been the first person to scan [Control] from hardcopy. Or he had to enter a valid username and password combination to the server. (Not shown in the figure.) Or his device came from an Internet address that was coded into the server to give it this privilege. The latter might be where Bob works for the publisher who make the hardcopy. The publisher gave the server an approved set of Internet addresses from which Bob could connect, in order to get supervisory authority.

Other ways are possible. Including where 1 or more of the previous steps were combined, including being combined with other steps not mentioned here.

The point is that the same hardcopy can be read by different devices and produce different actions or choices to different users. Logic of arbitrary complexity can be done to devise more intricate cases.

One immediate example is where FIG. 11 only has Bob controlling 1 set of buttons for Jill, that set having 3 buttons (red, green, blue). Bob might have 2 sets of controls. One set does the previous. A second set lets Bob independently control a second set of 3 buttons (low, medium, high) used by Jill.

A second example is to see that FIG. 11 has Bob and Jill scan the same hardcopy having [Control]. Instead, Bob might scan that hardcopy, while Jill scans a differently worded hardcopy [Jill's Buttons].

A third example is where Bob turns on (enables) the 3 buttons for Jill). Then Jill turns off the red button. This particular button turns off (disables) Bob's button, which then goes into the state Off. The point about this example is that it shows how each control page can turn off the opposite page.

6: Scanning Text to Find Linkets;

Consider a scenario of a user Jill reading a hardcopy paper. The paper might not have any linkets explicitly in it. But she wants to use her mobile device to scan the text and find possible candidates for a linket. This can be done by her manually scanning the text line by line. Her device does OCR to find the digital words. Suppose her device (or more likely its server) has earlier spidered Wikipedia, IMDB and similar databases and found a list of word topics. Then each newly scanned word from the paper can be compared to see if it is in a hash table of spidered word topics. If so, her device might add that newly scanned word to a list of possible linkets.

This process can be altered slightly if we suppose Jill to be first operating on a digital text stream in order to make possible linkets. After which, the text stream is amended to write in the chosen linkets, and then the stream is converted to hardcopy.

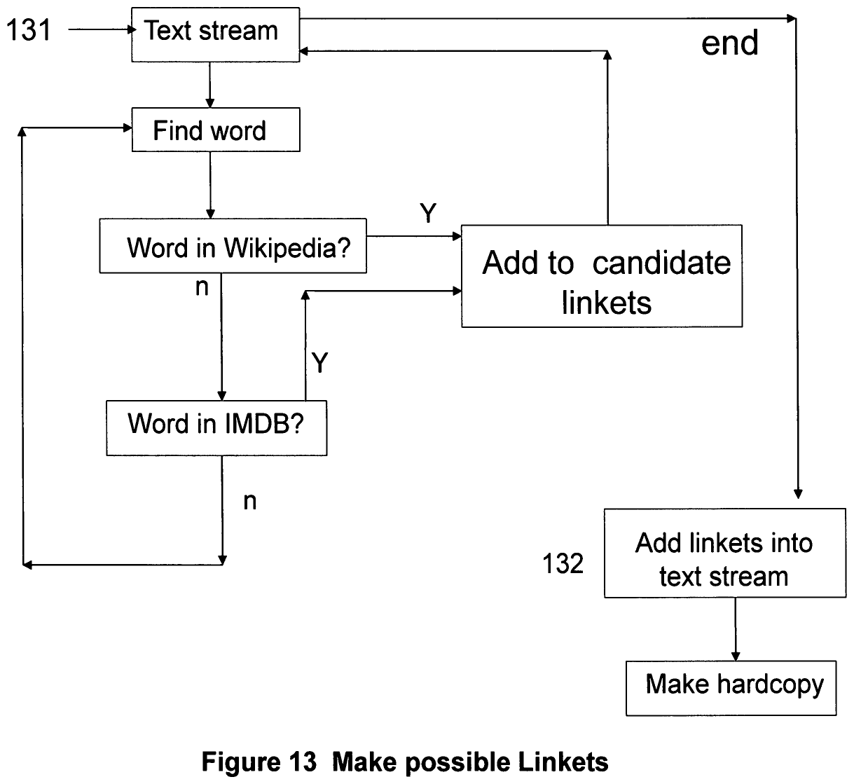

FIG. 13 shows a simplified flow chart. Item 131 is the start. Many steps could be added. For example, there could be a trimming of possible linkets, simply to prevent too many linkets being made.

Also, candidate linkets might be exposed to advertisers. They can bid to own certain linkets. A linket which gets bids from several advertisers might be a strong candidate to be an actual hardcopy linket, given the interest by advertisers. Or a linket might attract only 1 bid, but if that bid is above a certain minimum, this might be taken by the firm as evidence of popularity of the linket.

Another possibility is an advertiser who wants their linket to be more prominent. Suppose a given hardcopy page has the linket [Soda]. The advertiser who bought or rented this might pay to prevent any other linket on the current page.

Or perhaps the advertiser only wants to prevent linkets that sell soda. Linkets on other topics are ok. The fee the advertiser pays might be less in this case than the previous.

The paper can charge a fee for this exclusiveness.

Thus item 132 acts as a proxy of much complexity.

7: Improved Energy Efficiency;

This application offers less energy use. When user Jill reads a hardcopy paper, there is no marginal energy use by her electronic devices. When a cellphone (or other electronic device) is being used to read a page on the screen, the phone has to spend energy to actively show that page. Whereas when Jill reads an actual paper, the increased energy expenditure is 0.

This is a tangible and objective merit of our application. In this year 2021 of writing, there is growing concern in the US and other countries about overall energy use. The electricity to recharge a phone can come from burning coal, oil or gas. And even the use of wind turbines or solar panels still has a marginal cost of transmission. By deliberate intent, our application hopes to reduce (however modestly) net energy use.

A second issue is the use of an app to decode a linket to digital form via OCR versus using a QR barcode decoder to decode a QR code to digital form. We suggest that decoding the linket uses less energy. While we admit that numbers maybe hard to come by, engineering intuition should make this plausible. The linket has no built in error detection and correction. Whereas a QR code does. So encoding a QR code with ECC and then decoding it should take more computational effort and so more energy use. (This is for a linket and QR code using the same string.)

Related to these remarks is a reduced need to recharge mobile devices. Many phone users experience stress when their phone batteries are running low or empty. There is often a period of trying to find places where they can recharge. Our application also offers tangible improvements in this case.

8: Social Justice;

As mentioned earlier, the conventional use of the Web has led to domains being widely used as brands. Especially where the domains are English words. So domains like voice.com sold for $30 million, internet.com for $18 million etc. This has led many US startups to be unable to afford buying a single word English domain when that word is commonly used. And startups founded by women or people from minority communities tend to raise less money and are even less able to afford such domains. All this does is perpetuate existing inequalities when a female-led or minority-led startup cannot even startup with a useful domain.

Whereas with linkets, there can now be brands like [Voice], [Cars] etc, at cheaper prices than the corresponding domains. Thus his application can lead to linkets being new types of brands, which are likely (at least initially) to be more affordable to new firms led by historically disadvantaged founders.

There is a further broader context. When Indians and Chinese first met the Web in the 1990s, many now valuable domain names (often English words) had already been bought by Americans and Europeans. The best virtual real estate had already been taken. To Indians, Chinese and others, such might seem like 19 century neo-colonialism. Whereas linkets can be in Unicode, which means they can be written in Hindi, Tamil, Arabic, Chinese etc. so all languages can be treated equally.

We suggest that a merit of this application is a global push for greater social equity. We argue that if this application were to be filed in (eg) India, Brazil or China, that these broader contexts be taken into account when considering this application for approval. Many countries that approve patents have some consideration for social merit or utility.

9: Column Oriented Linkets;

Most languages are printed left to right. The only major exceptions are Arabic and Hebrew which are right to left. Only 1 major language is sometimes written top to bottom—Chinese. The question is what delimiters, if any, can be used for Chinese linkets in this case.

One case is to prepend to the top Chinese symbol a ‘[’. And the last Chinese symbol in the linket has a trailing ‘]’.

An alternative is to take the ‘[’ and rotate it 90 degrees clockwise. Then it might sit above the first Chinese symbol, as a cap. A similar thing is done with the ‘]’ at the bottom.

10: Auditory Search;

Previously we described how user Jill has a mobile device that she uses to scan printed text, to read a printed linket and convert it to electronic form. An alternative is where Jill is reading the hardcopy paper. She comes across a linket like [BBQ Ribs]. She says (eg) “linket BBQ Ribs”. Here she might say a keyword preceding “BBQ Ribs”. For simplicity we take that keyword to be “linket” but it could be any keyword that her device would recognise as a keyword. For example if her mobile device is an Amazon device, she might say “Alexa” as the keyword.

FIG. 3 can be easily modified so that the scanned output from mobile device 32 is now the electronic text “BBQ Ribs” found from an Automatic Speech Recognizer in device 32. The electronic text might be “[BBQ Ribs]”, where the keyword was detected and caused the enclosure of the ASR text in the brackets. The electronic linket can then be processed by the server as described earlier.

11: Changing Linkets;

Thus far, if a hardcopy has the printed text [XYZ123] and Jill scanned it with her phone, then the scanned digital code would be [XYZ123], the exact transformation of the original hardcopy (at least from her perspective). But there are alternatives. Suppose the hardcopy said [BBQ Ribs]. She scans it. But now the digital output on her device screen might say:

“Sorry we are out! But you can try [Pot Roast], [Dim Sum], [Sushi].”

The server that maps from a linket to its destination can have a string like the above. Note that embedding linkets into this string is allowed but not required. The destination text can be written in some language like HTML. It could have normal links to various items for purchase. The linkets in the above example are purely optional.

12: Edge Storage;

See FIG. 3. This application offers a type of edge storage, in contrast to storing data in the cloud. The latter refers to using storage at central data locations in the net. While edge storage means storing data close to where the data was generated.

The edge storage here does not refer to the computational cost of storing and reading the hardcopy. That is taken to be zero. It refers to when the user scans a linket with her mobile device and the device sends the digital decoding to a server to find the referenced data, which is then shown on the mobile device.

This data is much less than the typical examples given in the literature for edge storage. Those might be when a surveillance camera is used for days, and the resulting video is stored on a device near the camera. It is possible to easily accrue gigabytes of data. Whereas our application would generate only a few kilobytes. In part because decoding a linket that is a brand name would only be done a few times per hour. As opposed to a continual data streaming context.

The edge storage here may be considered a simple type of Content Delivery Network (CDN).

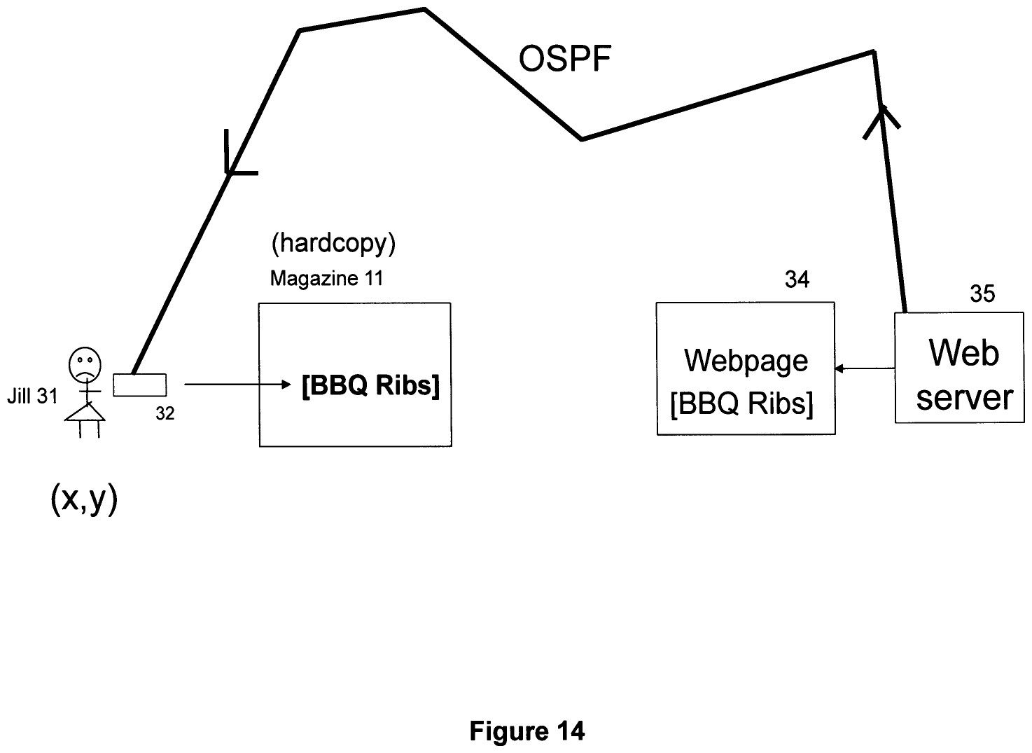

A second advantage is the short distance between the user's mobile device and the web server which serves a webpage that a linket points to. FIG. 14 is derived from FIG. 3. After Jill uses her mobile device 32 to scan a hardcopy paper, Web server 35 sends a webpage for [BBQ Ribs] to device 32. That page traverses the Internet. Usually the page taken on the Internet is automatically found via the Open Shortest Path First (OSPF) algorithm. The solid zig zag line between items 35 and 32 is meant to symbolise this path. Much research shows the OSPF is often the shortest path using the Internet network. This means low latency (low delay). And low power consumption. If a packet takes a longer path, it increases the chance that more power will be needed to drive the packet to its destination.

This is reinforced by a third factor. If a linket in question is for a use where the vendor (here a BBQ restaurant) is near the user, this also reduces the distance traveled on the network.

(FIG. 14 simplifies by showing 1 path between items 35 and 32. The Internet is designed to handle multiple paths due to congestion. But de facto, barring any unusual net outage, the single path of FIG. 14 is a reasonable depiction.)

Given the recent heat waves (2021), there has been increasing global concern about efficient power consumption. Thus we see how the methods of this section attack this problem.

13: Variants;

In FIG. 3, the magazine might be replaced by a physical billboard. Or it might be a hardcopy flyer handed out by a person outside a mall.

Also, the “magazine” might be in electronic form, like as a webpage or in a mobile app. In general, our remarks in this application about hardcopy can largely also pertain to an electronic format.

The magazine might be “electronic paper”. This refers to a tablet-like device or “paper” on which text can be programmed into it and displayed. The text can be redrawn to new text. In the context of this application, there is little change.

When the user Jill reads a hardcopy and uses a mobile device to scan a linket in it, she might be using a mobile app installed on the device. Or her mobile device might have this functionality built into the mobile operating system. This is already available in east Asia for decoding QR codes.

14: TV and Video Feeds;

TV frequently shows text. Today's TV feed is already digitized. A TV station can output its feed via a transmitter on a hill. It can also feed this as a datastream via fiber to the Internet. For an air (wireless) transmission the receiver can be some device adapted to do so. This includes a PC or laptop with suitable ancillary hardware. Or a mobile device with similar hardware. If transmission is via optical fiber, existing mobile hardware might need little or no modification to get the feed.

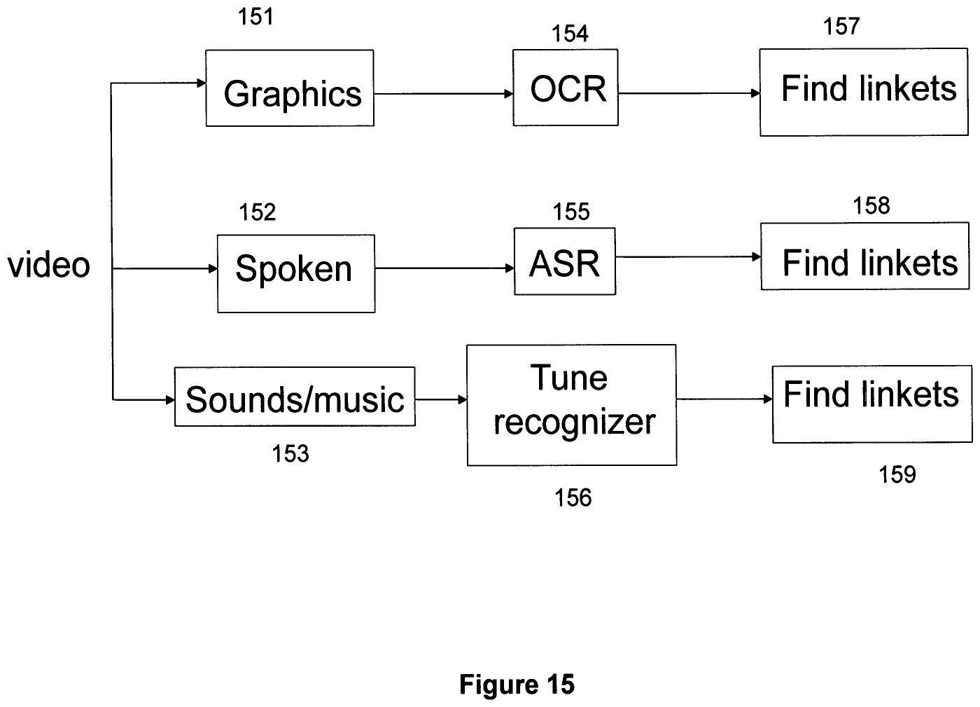

FIG. 15 shows how a TV or video feed can be analyzed. Video can be divided into 3 parts. Graphics 151 is the purely visual data. Sometimes this is just called video when it is clear from the context that this excludes sounds. Spoken 152 is more often called audio.

We divide audio into 2 parts. Spoken 152 is audio spoken by humans or by Text To Speech (TTS) programs. Sounds/music 152 is sounds coming from musical instruments and from animals. And also from machinery.

Items 157, 158 and 159 are all labelled ‘find linkets’. But the methods of each can be quite different.

14.1: Graphics;

OCR was designed to scan hardcopy and transform analog to a digital feed. When the input feed is already digitized, it is straightforward to replace the initial analog conversion. Also, in a digital feed, a frame can be extracted and analyzed on its own. This is equivalent to using OCR on a static piece of paper. For a digital feed, several adjoining frames might be compressed for speed. But decoding into a single frame can be done.

The steps in earlier sections to analyze a single digitized image can be used here.

A few remarks pertain. Suppose a video shows a frame of a shopfront that has the sign “Coffee”. We extract the frame from the video. Even though all the steps are digital, that does not mean the letters in the sign are digitized. The “C” in “Coffee” will not in general be represented in ASCII or Unicode by the letter “C”. This differs from a video where there is an overlay of credits about the video. A string in the credits like “Produced by” might indeed be in ASCII. It depends on how the video is stored. Readers who use the software tools Photoshop and Maya may be familiar with the issues.

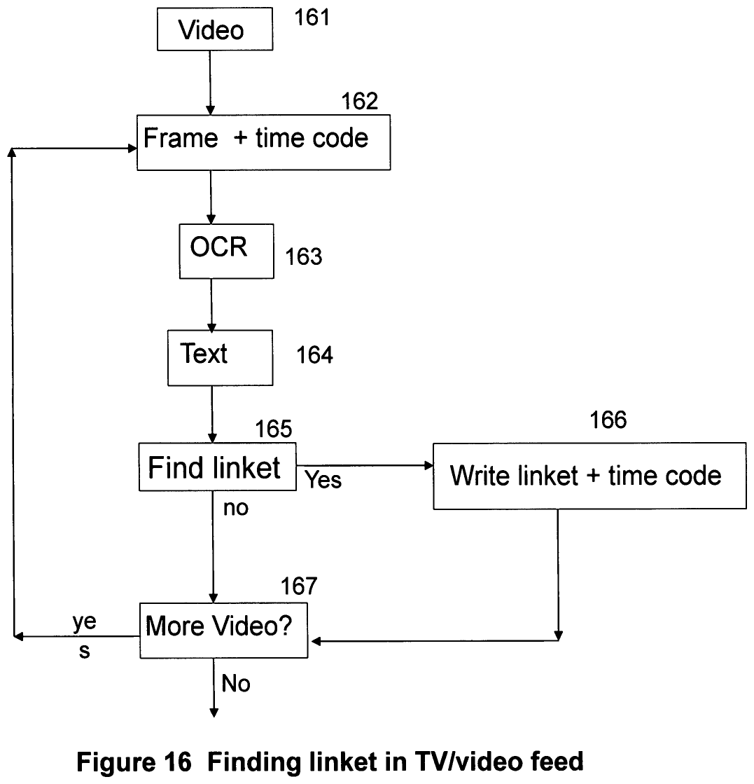

Frames from the video feed can be run thru an OCR to find text. See FIG. 16. We start with the video at 161. At step 162 a frame has been found at a given Time Code (TC). In film and TV, a fundamental parameter is the TC for each frame. The TC might be that of a frame in which overlay text is written, like for closed captioning in the language being spoken or to write in another language.

Step 163 shows the use of the OCR to find text 164, if the text exists at that TC. Step 165 tries to convert parts of the text to a linket. If successful, step 166 writes the linket and TC to the database.

The database might be also populated by looking at other videos or hardcopy. But the database for FIG. 16 has a difference compared to earlier sections. Now each linket found from the current video feed also has the TC written to the database.

Step 167 looks thru the video till the end. There is a key nuance. Suppose a linket [Soda] was found at time=0, based on text in the feed “soda”. The text in the feed might persist for say 5 seconds. If this “analog” text persists, there is no need to find new linkets in this duration. One way is to move forward In time thru the feed from t=0. Say in 2 second increments. This will eventually move past t=5. More elaborate methods can be done. For instance, instead of a constant time increment of 2 seconds, an exponentially increasing increment can be chosen, to more quickly pass over cases where there might be long durations of scenes with the same analog text shown. This is similar to the success of using exponential durations in TCP/IP collisions.

For cases where the database had linkets found from hardcopy, these linkets have no TCs.

A use of FIG. 16 is when the TV video feed can be replayed. This is germane when the feed goes out on the Internet and viewers can watch or re-watch the video at their volition. Now assume that the second and later copies of the video are shown in an app or browser window where:

(For example) Outside the video area, when the video plays and reaches a TC corresponding to a found (or made) linket, the linket (eg [Green Soda]) appears on the screen, under the video, say. The browser or app could implement the linket as a clickable link. Clicking the linket can lead (if done in a browser) to the URL pointed to by the linket being picked and a second browser tab made where the URL is put into the address bar. Or the linket could appear as an overlay on the video, where the linket can be clicked by the viewer.

While the remarks of the previous paragraph were directed to the video being in a browser, similar actions could be done if the video appeared in an arbitrary app.

The linket might instead be shown as a selectable overlay on top of the video. The viewer can select it, causing the associated webpage to be shown.

The steps of FIG. 16 pertain not to the end user who will watch the video, but to an editor who watches the video and then writes up the linkets and the associated TCs and the video. So that the combined entity can be watched by end users. In the parlance of TV and film, FIG. 16 is a set of post production steps.

Another issue is the duration—how long to show a linket? If this is based on the presence of analog text in the video that appears for, say, 2 seconds, should the linket just appear for those 2 seconds? This can be left up to the editor. So the TC that appears for a linket can be the starting time. Then there might be a duration for the display of the linket. It may be that the editor will want the linket to persist as a clickable link for several seconds longer than the original analog text.

14.2: Spoken;

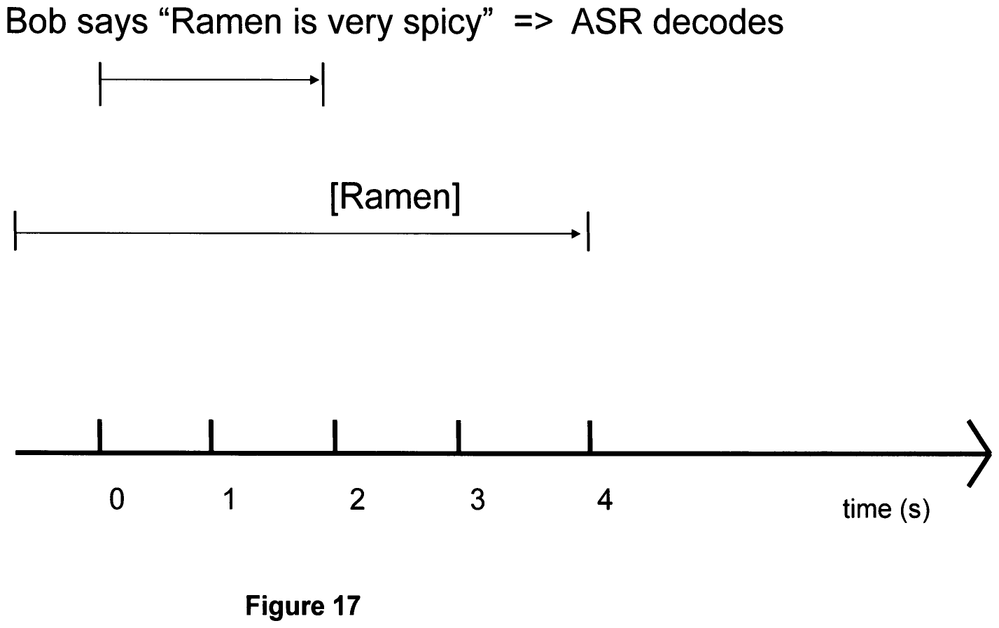

Spoken audio can be analyzed by ASR 155. FIG. 17 shows a user Bob saying “Ramen is very spicy”. This can be decoded by an ASR. An editor infers that the linket [Ramen] might be of interest to viewers of the video. FIG. 17 shows that she has [Ramen] appear from before t=0 to t=4 seconds. Whereas Bob's speech only goes from t=0 to t=2 seconds. This shows that a linket that corresponds to a speech can be visible before the speech starts, and it can last longer than the speech.

14.3: Sounds/Music;

This can be analyzed by a tune recognizer 156. These are readily available and can detect well known tunes to high accuracy. The remarks in section 14.2 can be readily applied here. The only difference is that the example now would be of, say a well known tune that is recognized by the tune recognizer. And an associated linket would be make by the editor, where the linket could exist from before when the tune was started and the tune can exist seconds after the tune has stopped.

We claim:

1. A system of a first mobile device interacting with a server and a printed document;
the printed document having a hardcopy linket;
the hardcopy linket containing a printed text string;
scanning, by the first mobile device, the printed document via Optical Character Recognition (OCR), to make an electronic linket;
sending, by the first mobile device, the electronic linket to the server;
sending, by the first mobile device, a location of the first mobile device to the server;
comparing, by the server, the electronic linket to a database of linkets;
sending, by the server, a signal to the first mobile device;
the signal containing information about a linket picked from the database;
displaying, by the first mobile device, the signal.

2: The system of claim 1, where the server finds a linket close to the location of the first mobile device.

3: The system of claim 1, where the signal contains information about one or more linkets picked from the database.

4: The system of claim 1, where the signal lists an exact match between the electronic linket and a linket in the database;
where the signal includes other linkets in the database;
where the other linkets are of similar topics to the electronic linket.

5: The system of claim 4, where an owner of the electronic linket pays a fee to the server; where the server does not show linkets that are not an exact match to the electronic linket.

6: The system of claim 1, where the electronic linket is in the database; where the server sends a current price of an item referred to by the electronic linket in the signal to the first mobile device.

7: The system of claim 6, where the first mobile device pays the current price to buy the item.

8: A system of a first mobile device, a second mobile device, a server and a first copy and a second copy of a printed document;
scanning, by the first mobile device, a text from the first copy;
sending, by the first mobile device, the text to the server;
comparing, by the server, the text to a database of linkets, each linket containing a string;
extracting, by the server, a linket from the database;
extracting, by the server, an URL from the database, the URL associated with the linket;
sending, by the server, the URL to the first mobile device;
displaying, by the first mobile device, a first webpage pointed to by the URL;
picking, by the first mobile device, a choice from the first webpage;
recording, by the server, the choice;
scanning, by the second mobile device, the text from the second copy;
sending, by the second mobile device, the text to the server;
comparing, by the server, the text to the database of linkets;
extracting, by the server, the linket from the database;
sending, by the server, the URL to the second mobile device;
displaying, by the second mobile device, a second webpage pointed to by the URL;
using, by the server, the choice, to modify the second webpage.

9: The system of claim 8 where:
the choice disables all selectable entries in the second webpage.

10; The system of claim 8 where:
the choice enables all selectable entries in the second webpage.

11: The system of claim 8 where:
the first mobile device is at an address on a list of approved addresses.

12: The system of claim 8 where:
the first mobile device sent a valid username and password to the server.

13: The system of claim 8 where:
sending, by the server, the linket to the first mobile device;
displaying, by the first mobile server, the linket.

14: The system of claim 9 where:
sending, by the server, the linket to the second mobile device;
displaying, by the second mobile device, the linket.

15: A method of showing video by using a database of linkets;
each linket containing a text string;
scanning the video from the start to the end, while:
[a] finding a frame in the video, and a time code of the frame,
[b] applying Optical Character Recognition (OCR) to the frame to find a first text,
[c] finding a first string in the first text, where the first string corresponds to a linket in the database,
[d] writing the linket and time code to the database.

16: The method of claim 15, where:
after writing the linket and time code, proceeding through the video via jumping to later frames; each jump done at an exponentially increasing number of frames.

17: The method of claim 15, where:
a user watches the video in a first window;
the video shows a frame;
a second window shows a linket associated with the frame;
the linket is picked by the user;
a webpage associated with the linket is shown.

18: The method of claim 15, where:
a user watches the video in a first window;
the video shows a frame;
a second window shows a linket associated with the frame;
the linket is picked by the user;
an app associated with the linket is shown.

19: The method of claim 15, where:
a user watches the video;
the video shows a frame;
a linket associated with the frame appears as a selectable overlay on the video;
the linket is picked by the user;
a webpage associated with the linket is shown.

20: The method of claim 15, where:
a user watches the video;
the video shows a frame;
a linket associated with the frame appears as a selectable overlay on the video;
the linket is picked by the user;
an app associated with the linket is shown.
